(19) United States
(12) Patent Application Publication
(10) Pub. No.: US 2024/0425034 A1
(43) Pub. Date: Dec. 26, 2024

(54) APPARATUS FOR PERFORMING AFTER-BLOW FUNCTION IN HYBRID VEHICLE, SYSTEM INCLUDING SAME, AND METHOD OF OPERATING SAME

(71) Applicants: Hyundai Motor Company, Seoul (KR); Kia Corporation, Seoul (KR)

(72) Inventor: Sung Ik JO, Hwaseong-si (KR)

(73) Assignees: Hyundai Motor Company, Seoul (KR); Kia Corporation, Seoul (KR)

(21) Appl. No.: 18/388,997

(22) Filed: Nov. 13, 2023

(30) Foreign Application Priority Data
Jun. 20, 2023 (KR) 10-2023-0079109

(51) Int. Cl. B60W 20/13; B60W 10/02; B60W 10/06; B60W 10/08; B60W 10/10; B60W 10/26; B60W 50/08; B60W 50/14

(52) U.S. Cl. CPC B60W 20/13; B60W 10/02; B60W 10/06; B60W 10/08; B60W 10/10; B60W 10/26; B60W 50/087; B60W 50/14; B60W 2510/244; B60W 2555/20

(57) ABSTRACT

Provided are an apparatus capable of performing an after-blow function without a separate after-blow apparatus, a system including the apparatus, and a method of operating the apparatus. The apparatus for performing an after-blow function may include an air conditioner, and a controller configured to predict a target state-of-charge (SOC) value based on setting information for the after-flow function which is performed using the air conditioner, and for-use-in-target-SOC value-prediction information which is used in predicting the target SOC value for securing an SOC value necessary to perform the after-flow function, and to control the hybrid vehicle's traveling to a destination so that an SOC value at the destination at which the after-blow function is performed becomes the target SOC value.

### CROSS REFERENCE TO RELATED APPLICATION

The present application claims priority to Korean Patent Application No. 10-2023-0079109, filed Jun. 20, 2023, the entire contents of which is incorporated herein for all purposes by this reference.

### BACKGROUND OF THE PRESENT DISCLOSURE

### Field of the Present Disclosure

The present disclosure relates to an after-blow in a hybrid vehicle, and more particularly, to an apparatus capable of performing an after-blow function without a separate after-blow apparatus, a system including the apparatus, and a method of operating the apparatus.

### Description of Related Art

After-blow is a technology for preventing dew condensation in an evaporator by operating a separate blow device after operating an air conditioner. By utilizing the after-blow, the growth of fungus may be suppressed, and the occurrence of odor may be prevented.

Generally, an after-blow apparatus is not provided as an operation for a vehicle due to concerns about battery discharging during operation. For the present reason, users who want an after-blow function need to purchase a separate after-blow apparatus and mount it to their vehicles. Therefore, the users face the problem of bearing expenses for purchasing and installing the after-blow apparatus.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus for performing an after-blow function in a hybrid vehicle, the apparatus being configured for performing the after-blow function without a separate after-blow apparatus, a system including the apparatus, and a method of operating the apparatus.

Various aspects of the present disclosure are directed to providing an apparatus for performing an after-blow function in a hybrid vehicle, the apparatus being configured for securing a state-of-charge (SOC) value for performing the after-blow function, through a charging-oriented traveling, before the hybrid vehicle arrives at a destination (including a parking lot and a stop), a system including the apparatus, and a method of operating the apparatus.

Still various aspects of the present disclosure are directed to providing an apparatus for performing an after-blow function in a hybrid vehicle, the apparatus being configured for securing a state-of-charge (SOC) value for performing the after-blow function, based on destination (including a parking lot and a stop) information of the hybrid vehicle, information on a traveling path to the destination, information on a road on the traveling path, information on weather over the traveling path, information on weather over the destination, state information of the hybrid vehicle, SOC value information, user-required information, and the like, a system including the apparatus, and a method of operating the apparatus.

The present disclosure is not limited to the above-mentioned objects. from the following the present disclosure, other objects unintended in the present specification would also be clearly understandable to a person of ordinary skill in the art to which an exemplary embodiment of the present disclosure pertains.

As means for accomplishing the above-mentioned objects, there may be provided an apparatus for performing an after-blow function in a hybrid vehicle, the apparatus being configured for performing the after-blow function without a separate after-blow apparatus, a system including the apparatus, and a method of operating the apparatus.

According to various aspects of the present disclosure, there is provided an apparatus for performing an after-blow function in a hybrid vehicle, the apparatus including: an air conditioner; and a controller configured to predict a target state-of-charge (SOC) value based on setting information for the after-flow function which is performed using the air conditioner, and for-use-in-target-SOC value-prediction information which is used in predicting the target SOC value for securing an SOC value necessary to perform the after-flow function, and to control the hybrid vehicle's traveling to a destination so that an SOC value at the destination at which the after-blow function is performed becomes the target SOC value.

In the apparatus, the setting information may include after-blow performing-non-performing information, after-blow strength-level information, after-blow duration time information, and destination information.

In the apparatus, the target SOC value may include a for-after-blow-performing SOC value necessary to perform the after-blow function and a for-motor-driving SOC value necessary for motor driving while the hybrid vehicle drives to the destination.

In the apparatus, the controller may be configured to predict an initial target SOC value based on initial setting information and initial for-use-in-target-SOC value-prediction information and may update the initial target SOC value when at least one of the setting information and the for-use-in-target-SOC value-prediction information is changed while the hybrid vehicle drives.

In the apparatus, the controller may continuously obtain a current SOC value while the hybrid vehicle travels, and when the current SOC value falls short of the target SOC value, may enable charging-oriented traveling so that the current SOC value becomes the target SOC value.

In the apparatus, the controller may perform the after-blow function in a case where an IG OFF state is attained when the hybrid vehicle arrives at the destination and where a predetermined condition is satisfied.

In the apparatus, the controller may perform the after-blow function in a case where humidity at the destination, a difference between inside air and outside air, or time during which the air conditioner operates while the hybrid vehicle travels satisfies a preset condition.

In the apparatus, the controller may perform the after-blow function based on after-blow strength-level information and after-blow duration time information that are included in the setting information.

In the apparatus, the controller may perform the after-blow function based on after-blow strength-level information, which is included in the setting information, and after-blow performing time information, which is generated while the target SOC value is determined.

According to various aspects of the present disclosure, there is provided a system for performing an after-blow function, the system including: a user input interface configured to receive setting information input from a user: a for-use-in-target-SoC-prediction information provision unit configured to provide for-use-in-target state-of-state (SOC) value prediction information which is used in predicting a target SOC value for securing an SOC value necessary to perform after-blow; and the apparatus.

In the system, the apparatus may enable the SOC value at the destination to become the target SOC value by controlling an engine control unit, a motor control unit, a transmission control unit, a battery management system, and an engine clutch.

In the system, the user input interface may be a user setting menu (USM), and the apparatus may be a hybrid control unit (HCU).

According to yet another aspect of the present disclosure, there is provided a method of operating an apparatus for performing an after-blow function in a hybrid vehicle, the method including: predicting a target state-of-charge (SOC) value for securing an SOC value necessary to perform after-blow based on setting information and for-use-in-target-SOC value-prediction information: comparing a current SOC value which is obtained while the hybrid vehicle travels and the target SOC value: performing control so that charging-oriented traveling is enabled, when the current SOC value falls short of the target SOC value; and performing the after-blow function when a hybrid vehicle arrives at a destination.

In the method, in the predicting of the target SOC value, a for-after-blow-performing SOC value necessary to perform the after-blow function may be predicted, a for-motor-driving SOC value necessary for motor driving while the hybrid vehicle drives to the destination may be predicted, and the target SOC value may be predicted based on the for-after-blow-performing SOC value and the for-motor-driving SOC value.

In the method, in the predicting of the target SOC value, an initial target SOC value may be predicted based on initial setting information and initial for-use-in-target-SOC value-prediction information, and the initial target SOC value may be updated when at least one of the setting information and the for-use-in-target-SOC value-prediction information is changed while the hybrid vehicle drives.

In the method, the comparing of the current SOC value which is obtained while the hybrid vehicle travels and the target SOC value may be performed after the charging-oriented traveling is enabled.

In the method, in the performing of the after-blow function, when the hybrid vehicle arrives at the destination, in a case where a preset condition is satisfied, the after-blow function may be performed.

In the method, in the performing of the after-blow function, in a case where the hybrid vehicle is in an IG OFF state and where humidity at the destination, a difference between inside air and outside air, or time during which an air conditioner operates while the hybrid vehicle travels satisfies a preset condition, the after-blow function may be performed.

In the method, in the performing of the after-blow function, the after-blow function may be performed based on after-blow strength-level information and after-blow duration time information that are included in the setting information.

In the method, in the performing of the after-blow function, the after-blow function may be performed based on after-blow strength-level information, which is included in the setting information, and after-blow performing time information, which is generated while the target SOC value is determined.

Means other than the above-mentioned means for accomplishing the objects would be determined from the following detailed description of the present disclosure and the accompanying drawings.

According to the exemplary embodiments of the present disclosure, the apparatus for performing an after-blow function, the apparatus being mounted in the hybrid vehicle, the system including the apparatus, and the method of operating the apparatus may be provided.

According to the exemplary embodiments of the present disclosure, the state-of-charge (SOC) value for performing the after-blow function may be secured through the charging-oriented traveling before the hybrid vehicle arrives at the destination (including the parking lot and the stop).

According to the exemplary embodiments of the present disclosure, the after-blow function is performed using the air conditioner which is pre-mounted in the hybrid vehicle. This eliminated the need to install a separate after-blow apparatus.

Thus, expenses for purchasing and installing the after-blow apparatus may be saved, and the advantage of economically realizing the after-blow function may be achieved.

Furthermore, an after-blow operation is performed in a case where a preset condition for the after-blow operation is satisfied after the hybrid vehicle arrives at the destination. Therefore, a condition for the after-blow operation is preset to reflect user's needs, the after-blow operation may be performed such which is optimized for the user.

The advantage of the present disclosure is that information for use in the target SOC value prediction may be obtained from constituent elements pre-mounted in the hybrid vehicle and that the after-blow operation may be performed in software.

The present disclosure is not limited to the above-mentioned advantageous effects. An advantageous effect not mentioned above would be clearly understandable to a person of ordinary skill in the art.

The objects, the means for accomplishing the objects, and the advantageous effects, which are mentioned above, do not specify the essential features of the claims. The scope of the claims is not limited by matters described in the detailed description of the present disclosure.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a configuration of a system for performing an after-blow function according to various exemplary embodiments of the present disclosure;

FIG. 2 is a view exemplarily illustrating an example of a configuration of a high-level control unit (or an apparatus for performing an after-blow function) according to the exemplary embodiment of the present disclosure:

FIG. 3 is a view exemplarily illustrating a functional configuration of a controller of a high-level control unit according to the exemplary embodiment of the present disclosure:

FIG. 4 is a flowchart which is referred to for description of operations by the system for performing an after-blow function according to the exemplary embodiment of the present disclosure:

FIG. 5A is a table showing an example of a control state where charging-oriented control according to the exemplary embodiment of the present disclosure is performed.

FIG. 5B is a graph showing a result of conducting an experiment based on the control state in FIG. 5A; and

FIG. 6A and FIG. 6B are graphs each showing an experimental example which may be referred when realizing an algorithm for predicting a for-after-blow-performing SOC value.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Advantages and features of the present disclosure, and methods of achieving the advantages and the features will be apparent from embodiments that will be described in detail below with reference to the accompanying drawings. However, the present disclosure is not limited to the exemplary embodiments that will be included below and may be implemented in various different forms. The exemplary embodiments are only provided to make disclosure of the present disclosure complete and to provide definite notice as to the scope of the present disclosure to a person of ordinary skill in the art to which an exemplary embodiment of the present disclosure pertains. The scope of the present disclosure should be only defined by claims.

Constituent elements are illustrated in the drawings in an exemplary manner, considering factors such as shape, size, scale, angle, number, and the like to describe the exemplary embodiments of the present disclosure, and thus the present disclosure is not limited to these factors. Throughout the specification, the same reference numeral refers to the same constituent element. Furthermore, a specific description of a well-known technology associated with the present disclosure will be omitted when determined as making the nature and gist of the present disclosure obfuscated. When the phrases “include,” “have,” “is configured with,” and the like are used in the present specification, one or more other constituent elements may be added as long as the modifier “only” is not used. A noun in singular form includes the same meaning as when used in plural form, unless it includes a different meaning in context.

Unless otherwise explicitly described, when a constituent element is interpreted, a range of errors allowable for the constituent element should be taken into consideration.

When the terms “after,” “subsequently,” “next,” “before.” and the like are used to indicate which event comes before or after another in a temporal sequence, the events may occur continuously or discontinuously, as long as the adverb “immediately,” or “directly” is not used.

The terms “first,” “second,” and the like are used to describe various constituent elements that include the same function, but do not impose any limitation on the meanings of the various constituent elements. These terms are used only to distinguish among the various constituent elements that include the same function. Therefore, a first constituent element that will be described below may be named a second constituent element that falls within the scope of the technological idea of the present disclosure.

The ordinal numbers “first,” “second,” and so forth, the letters in upper case “A,” “B,” and so forth, the parenthesized letter in lower case “(a),” “(b),” and so forth, and the like may be used to describe constituent elements according to an exemplary embodiment of the present disclosure. These terms are only used to distinguish one constituent element from another constituent element and do not impose any limitation on the natures, the order, the sequence, the number, or other attributes of these constituent elements. It should be understood that a constituent element, when referred to as being “connected to,” being “coupled to,” or having “access to” a different constituent element, may be directly connected to, be directly coupled to, or have direct access to the different constituent element or may also be connected to, be coupled to, or have access to the different constituent element with a third constituent element in between.

The term “at least one” should be understood to include one or more constituent elements in question and combinations thereof. For example, the expression “at least one of first, second, and third constituent elements” means not only the first, second, or third constituent element, but also combinations of two or more of the first, second, and third constituent elements.

Respective features of the exemplary embodiments described in the present specification may be partially or wholly coupled to or combined with each other. Furthermore, constituent elements according to the exemplary embodiments of the present disclosure may operate individually and in unison with each other. Furthermore, the exemplary embodiments of the present disclosure may also be implemented individually and in unison with each other.

The exemplary embodiments of the present disclosure will be described below with reference to the accompanying drawings. For convenience in description, constituent elements that are illustrated in the drawings are scaled in a non-exact proportion and thus are not limited to the present scaling.

A hybrid vehicle-mounted apparatus for performing an after-blow function, a system 1 that including the apparatus, and a method of operating the apparatus according to embodiment of the present disclosure will be described below with reference to the accompanying drawings.

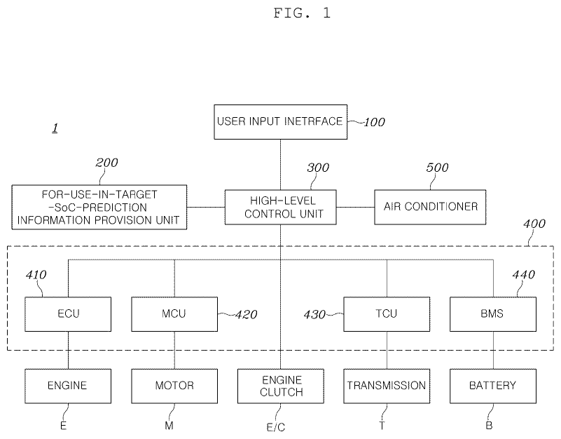

FIG. 1 is a view exemplarily illustrating the system 1 for performing an after-blow function according to the exemplary embodiment of the present disclosure.

With reference to FIG. 1, the system 1 for performing an after-blow function according to the exemplary embodiment of the present disclosure may be mounted in a hybrid vehicle.

Based on information obtained, the system 1 for performing an after-blow function according to the exemplary embodiment of the present disclosure may be configured to predict a state of charge (SOC) value at the destination (a for-after-blow-performing SOC value) for performing after-blow (or an after-blow function) and may be configured to predict an SOC value (a for-motor-driving SOC value) necessary for motor driving during traveling to the destination.

The system 1 for performing an after-blow function may be configured to predict a target SOC value based on the for-after-blow-performing SOC value and the for-motor-driving SOC value. The target SOC value here may be predicted by adding up the for-after-blow-performing SOC value and the for-motor-driving SOC value.

The system 1 for performing an after-blow function according to the exemplary embodiment of the present disclosure may be configured to predict after-blow performing time, before predicting the for-after-blow-performing SOC value, and then may be configured to predict the for-after-blow-performing SOC value, considering the predicted SOC value for performing after-blow.

Alternatively, the system 1 for performing an after-blow function may be configured to predict the for-after-blow-performing SOC value, considering setting time which is input from a user.

The system 1 for performing an after-blow function may continuously obtain a current SOC value of a battery while a vehicle drives, and when a current SOC value falls short of the target SOC value, may enable the current SOC value to become the target SOC value by performing charging-oriented control.

Furthermore, the system 1 for performing an after-blow function may update the target SOC value based on information which is obtained in real time while the vehicle drives.

When the vehicle arrives at the destination, the system 1 for performing an after-blow function may perform the after-blow function by operating an air conditioner. At the present point, when the vehicle arrives at the destination, if a predetermined condition is satisfied, the system 1 for performing an after-blow function may operate the air conditioner.

For example, the system 1 for performing an after-blow function checks whether or not humidity information, temperature information of inside and outside air, SOC value information, and the like satisfy a preset condition is satisfied, and when the preset condition is satisfied, may perform the after-blow function. However, the preset condition for performing the after-blow function is not limited to these factors.

The system 1 for performing an after-blow function according to the exemplary embodiment of the present disclosure may include a user input interface 100, a for-use-in-target-SoC-prediction information provision unit 200, a high-level control unit 300 (or a first control unit), a low-level control unit 400 (or second control unit), and an air conditioner 500. However, the system 1 for performing an after-blow function is not limited to these constituent elements.

The user input interface 100 according to the exemplary embodiment of the present disclosure is configured to receive an input from the user. The user input interface 100 may receive information (user-input information), as an input, and may provide the input information to the high-level control unit 300. In the exemplary embodiment of the present disclosure, the information which is input by the user is associated with a setting for the after-blow function. The information which is input by the user is hereinafter referred to as setting information. Information which is input before the vehicle drives is referred to as initial setting information to be distinguishable from information which is input after the vehicle drives.

For example, the user input interface 100 may be a user setting menu (USM), but is not limited thereto.

For example, after-blow performing-associated (enabling- and disabling-associated) information, after-blow strength-level (or intensity-level) information (for example, a weak-wind level, a middle-wind level, a strong-wind level, or an automatically adjusted level), after-blow duration time information, destination information and the like may be input through the user input interface 100. However, the user input interface 100 is not limited to these types of information.

A change may be made to the setting information which is input through the user input interface 100, and the setting information resulting from the change (change-resulting setting information) may be provided in real time to the high-level control unit 300.

The for-use-in-target-SoC-prediction information provision unit 200 according to the exemplary embodiment of the present disclosure may obtain information necessary for the high-level control unit 300 to predict the target SOC value and may provide the obtained information to the high-level control unit 300.

For example, the for-use-in-target-SoC-prediction information provision unit 200 may include at least one sensor that collects information associated with the vehicle, and at least one information collection module that collects external information. However, the unit 200 for providing information for use in target SOC value prediction is not limited to these constituent elements.

As an exemplary embodiment of the present disclosure, the for-use-in-target-SoC-prediction information provision unit 200 may provide information on a traveling path to a destination, information on a road on the traveling path (for example, a gradient, an estimated average speed, or the like), information on weather over the traveling path, information on weather over the destination, current SOC value information, inside air information, outside air information, information on driving behavior, vehicle driving information (for example, a vehicle speed, a motor speed, an engine speed, accelerator pedal information, brake pedal information, or the like), and air conditioner (A/C) operation history, and the like. However, the for-use-in-target-SoC-prediction information provision unit 200 is not limited to these types of information.

For example, the for-use-in-target-SoC-prediction information provision unit 200 may include a navigation device, a vehicle speed sensor, a motor speed sensor, an engine speed sensor, an outside air measurement sensor, an inside air measurement sensor, an accelerator position sensor (APS), a brake position sensor (BPS), a throttle position sensor (TPS), and the like. However, the for-use-in-target-SoC-prediction information provision unit 200 is not limited to these constituent elements.

At an early stage where the after-blow is set to be enabled, the for-use-in-target-SoC-prediction information provision unit 200 may provide for-use-in-target-SOC value-prediction information (initial for-use-in-target-SOC value-prediction information, pre-driving for-use-in-target-SOC value-prediction information, or first for-use-in-target-SOC value-prediction information). Furthermore, while the vehicle drives, the for-use-in-target-SoC-prediction information provision unit 200 may provide, in real time, for-use-in-target-SOC value-prediction information (during-driving for-use-in-target-SOC value-prediction information while driving or second for-use-in-target-SOC value-prediction information.

For example, a type of the initial for-use-in-target-SOC value-prediction information and a type of the during-driving for-use-in-target-SOC value-prediction information may be the same as each other or different from each other. Furthermore, the type of the initial for-use-in-target-SOC value-prediction information and the type of the during-driving for-use-in-target-SOC value-prediction information may be partially the same as each other.

The high-level control unit 300 according to the exemplary embodiment of the present disclosure may be configured to predict the target SOC value based on information from the user input interface 100 and information from the for-use-in-target-SoC-prediction information provision unit 200.

The high-level control unit 300 may be regarded as the apparatus for performing an after-blow function in a hybrid vehicle that realizes the after-blow function by controlling the air conditioner 500.

At the present point, the high-level control unit 300 may be configured to predict the SOC value (the for-after-blow-performing SOC value) necessary to perform the after-blow when the vehicle arrives at the destination, and the SOC value (the for-motor-driving SOC value) necessary for motor driving while the vehicle travels to the destination.

The high-level control unit 300 may be configured to predict the target SOC value based on the for-after-blow-performing SOC value and the for-motor-driving SOC value.

For example, the high-level control unit 300 may be a hybrid control unit (HCU).

The high-level control unit 300 may be configured to predict the initial target SOC value based on the initial setting information, which is provided from the user input interface 100 and the initial for-use-in-target-SOC value-prediction information (the first for-use-in-target-SOC value-prediction information or the pre-driving for-use-in-target-SOC value-prediction information), which is provided from the for-use-in-target-SoC-prediction information provision unit 200.

The high-level control unit 300 may update the initial target SOC valuebased on at least one of the change-resulting setting information, which is provided from the user input interface 100, and the during-driving for-use-in-target-SOC value-prediction information (or the second for-use-in-target-SOC value-prediction information), which is provided from the for-use-in-target-SoC-prediction information provision unit 200.

The initial target SOC value may be updated multiple times when at least one of the setting information provided from the user input interface 100 and the for-use-in-target-SOC value-prediction information provided from the for-use-in-target-SoC-prediction information provision unit 200 is changed.

For example, the target SOC value may be updated when the setting information is changed or when the for-use-in-target-SOC value-prediction information is changed. Furthermore, the target SOC value may be updated when the setting information and the for-use-in-target-SOC value-prediction information are changed.

The high-level control unit 300 may be configured for controlling a low-level electricity-powered component so that the current SOC value of the battery in the vehicle becomes the target SOC value.

The high-level control unit 300 according to the exemplary embodiment of the present disclosure may be configured for controlling low-level electricity-powered components in the vehicle, for example, such as an engine clutch (E/C) and the low-level control unit 400 (may perform the charging-oriented control), so that the current SOC value becomes the target SOC value.

As an exemplary embodiment of the present disclosure, the high-level control unit 300 may perform the charging-oriented control according to the SOC value that varies with the information on driving behavior, the information on a traveling path, or the like. As an exemplary embodiment of the present disclosure, the high-level control unit 300 may perform the charging-oriented control through power transmission (PT) control. Alternatively, the high-level control unit 300 may enable downward road (slope)-oriented traveling and non-congestion section traveling based on the information on a road on a traveling path, performing the charging-oriented control.

When the vehicle arrives at the destination, the high-level control unit 300 may perform the after-blow function by operating the air conditioner 500. For example, in a case where a predetermined condition is satisfied, the high-level control unit 300 may operate the air conditioner 500.

As an exemplary embodiment of the present disclosure, the high-level control unit 300 checks whether or not an engine status, the humidity information, the temperature information of inside and outside air, the SOC value information, the air conditioner (A/C) operation history, and the like satisfy a preset condition, and when the preset condition is satisfied, may operate the air conditioner 500. However, the high-level control unit 300 is not limited to these conditions for performing the after-blow function.

The high-level control unit 300 according to the exemplary embodiment of the present disclosure may perform the after-blow function in a case where an ignition (IG) OFF state is attained, where humidity is 80% or higher, where a difference between inside air and outside air is 15° C. or higher, where the air conditioner 500 operates for a 5 minutes or longer during traveling, and where the current SOC value reaches or exceed a preset for-after-blow-performing SOC value. However, the high-level control unit 300 is not limited to these conditions for the after-blow function.

For example, in a case where in an area where exhaust gas emissions from the vehicle are restricted, a travel mode for restricting engine drive, for example, a green-zone drive mode (GDM) is executed, the high-level control unit 300 may preferentially enable GDM traveling and then may perform the after-blow function.

The low-level control unit 400 according to the exemplary embodiment of the present disclosure may operate to perform the charging-oriented control under the control of the high-level control unit 300.

For example, the low-level control unit 400 may include an engine control unit (ECU) 410, a motor control unit (MCU) 420, a transmission control unit (TCU) 430, a battery management system (BMS) 440, and the like.

Among constituent elements of the low-level control unit 400, any arbitrary constituent element may control any other arbitrary constituent element.

The ECU 410 may operate the overall operations of an engine E, and the motor control unit 420 may be configured for controlling the overall operations of a motor M.

The TCU 430 may be configured for controlling a gear ratio of a transmission T by determining a target gear position for speed-up and speed-down according to a current vehicle speed and displacement of a throttle valve.

The BMS 440 may comprehensively collect a wide range of information, such as voltage, current, temperature, and the like of a battery B, and thus may manage and control an SOC value of the battery B and amounts of charged and discharged current of the battery B.

Two or more motors M may be included according to how a hybrid powertrain is configured. The engine clutch (E/C) may be disposed between the transmission T and the engine E, and one or more motor M may further be disposed between the transmission T and the engine E.

According to the exemplary embodiment of the present disclosure, with an arbitrary configuration, functions of the for-use-in-target-SoC-prediction information provision unit 200 and the low-level control unit 400 may be both performed. For example, with a configuration of the low-level control unit 400, the for-use-in-target-SOC value-prediction information may be provided, and with a configuration of the for-use-in-target-SoC-prediction information provision unit 200, a function of the low-level control unit 400 may be performed.

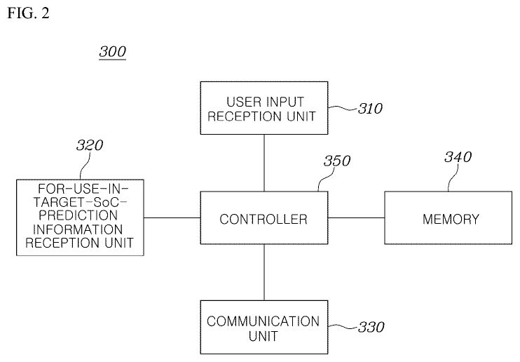

FIG. 2 is a view exemplarily illustrating an example of a configuration of the high-level control unit 300 according to the exemplary embodiment of the present disclosure.

With reference to FIG. 1 and FIG. 2, the high-level control unit (or the apparatus for performing an after-blow function) 300 according to the exemplary embodiment of the present disclosure may include a user input reception unit (a first reception unit) 310, a for-use-in-target-SOC value-prediction information reception unit 320 (or second reception unit), a communication unit 330, a memory 340, and a controller 350. However, the high-level control unit 300 are not limited to these constituent elements.

The user input reception unit 310 may operate in unison with the user input interface 100. The user input reception unit 310 may receive information which is input through the user input interface 100 and may transfer the received information to the controller 350.

According to the exemplary embodiment of the present disclosure, the user input reception unit 310 may receive information (setting information) associated with the performing of the after-blow function from the user input interface 100.

For example, the user input reception unit 310 may receive, as types of setting information, the after-blow performing-associated (enabling- and disabling-associated) information, the after-blow strength-level (or intensity-level) information (for example, the weak-wind level, the middle-wind level, the strong-wind level, or the automatically adjusted level), the after-blow duration time information, and the destination information.

According to the exemplary embodiment of the present disclosure, the user input reception unit 310 may receive the initial setting information which is the setting information which is initially input by the user, and may receive the change-resulting setting information that results from the user changing the initial setting information which is input.

The for-use-in-target-SOC value-prediction information reception unit 320 may operate in unison with the for-use-in-target-SoC-prediction information provision unit 200. The unit 320 for receiving for-use-in-target-SOC value-prediction information may receive information provided from the for-use-in-target-SoC-prediction information provision unit 200 and may provide the received information to the controller 350.

According to the exemplary embodiment of the present disclosure, the for-use-in-target-SoC-prediction information provision unit 200 may include a multiplicity of sensors and a multiplicity of information collection modules. Accordingly, the for-use-in-target-SOC value-prediction information reception unit 320 may be configured to include a multiplicity of reception units,

The communication unit 330 may perform a low-level electricity-powered component which is subject to control by the high-level control unit 300. For example, the communication unit 300 may perform communication with the engine clutch (E/C) and the low-level control unit 400.

The communication unit 330 may transfer a control command, which is input from the controller 350, to the engine clutch (E/C) and the low-level control unit 400, and may transfer a state information or a request, which is received from the engine clutch (E/C) or the low-level control unit 400, to the controller 350.

For example, the communication unit 330 may be configured with one or more communication modules. For example, the communication unit 330 may communicate with the low-level electricity-powered component (E/C) 400 through a Controller Area Network (CAN).

Stored in the memory 340 may be algorithms necessary for the controller 350 to operate (an algorithm for predicting the for-after-blow-performing SOC value, an algorithm for predicting the for-motor-driving SOC value, an algorithm for predicting the target SOC value, and the like), results of the controller 350 performing an operation, and the like.

For example, the algorithms for predicting an SOC value (which include the algorithm for predicting the for-after-blow-performing SOC value, the algorithm for predicting the for-moto-driving SOC value, and the target the algorithm for predicting the SOC value) that are stored in the memory 340 may be generated based on the results obtained through numerous experiments.

The memory 340 may include a non-volatile memory, such as a flash memory, a hard disk, a micro-type memory, or a card-type memory, (for example, a secure digital (SD) card, or an eXtream digital (XD) card), a read-only memory (ROM), a programmable ROM (PROM), an electrically erasable PROM (EEPROM), a volatile memory, such as a random access memory (RAM), a static RAM (SRAM), or a magnetic RAM (MRAM), and a storage medium, such as a magnetic disk or an optical disk.

The controller 350 may be configured with at least one processor. According to the exemplary embodiment of the present disclosure, the controller 350 may perform after-blow setting determination, prediction of the for-after-blow-performing SOC value, prediction of the for-motor-driving SOC value, target SOC value prediction, charging-oriented traveling control, and after-blow, and the like.

For example, the controller 350 may operate according to an operation-performing algorithm (for example, the algorithm for predicting an SOC value) stored in the memory 340.

The controller 350 may be configured to predict the for-after-blow-performing SOC value, the for-motor-driving SOC value, and the target SOC value based on the setting information (for example, the initial setting information) which is input through the user input interface 100 and the for-use-in-target-SOC value-prediction information (for example, the initial for-use-in-target-SOC value-prediction information), which is provided from the for-use-in-target-SoC-prediction information provision unit 200.

Furthermore, the controller 350 may re-predict the for-after-blow-performing SOC value, the for-motor-driving SOC value, and the target SOC value based on the setting information (change-resulting setting information) which is obtained while the vehicle drives and the for-use-in-target-SOC value-prediction information (the during-driving for-use-in-target-SOC value-prediction information).

The controller 350 may continuously obtain the current SOC value of the battery. When the current SOC value falls short of the target SOC value, the controller 350 may perform the charging-oriented control so that the current SOC value becomes the target SOC value.

When the vehicle arrives at the destination and the IG OFF state is attained, the controller 350 may perform the after-blow function by operating the air conditioner 500. At the present point, in a case where a predetermined condition is satisfied, the controller 350 may perform the after-blow function. According to the exemplary embodiment of the present disclosure, the predetermined condition may include a condition on whether or not the IG OFF state is attained.

For example, the controller 350 may receive, from a navigation system in the vehicle, a notification that the vehicle arrives at the destination and may receive the IG-OFF state from the low-level control unit 400.

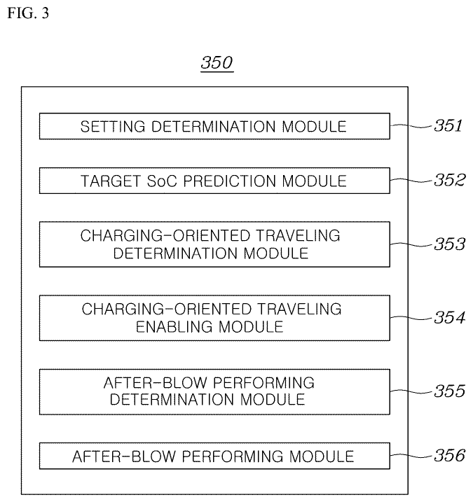

FIG. 3 is a view exemplarily illustrating a functional configuration of the controller 350 of the high-level control unit 300 according to the exemplary embodiment of the present disclosure.

With reference to FIG. 1, FIG. 2, and FIG. 3, the controller 350 according to the exemplary embodiment of the present disclosure may include a setting determination module 351, a target SOC prediction module 352, a charging-oriented traveling determination module 353, a charging-oriented traveling enabling module 354, an after-blow performing determination module 355, and an after-blow performing module 356. However, the controller 350 is not limited to these constituent elements.

The setting determination module 351 may be configured to determine whether or not the after-blow is performed, based on the setting information (for example, the after-blow performing-non-performing information) which is received through the user input reception unit 310.

For example, the setting determination module 351 may provide the target SOC prediction module 352 with a result of determining whether or not the after-blow is performed. As an exemplary embodiment of the present disclosure, when receiving the after-blow enabling information as the after-blow performing-associated information, the setting determination module 351 may output an after-blow enabling signal to the target SOC prediction module 352.

The target SOC prediction module 352 may be configured to predict the target SOC value based on the setting information (for example, the after-below strength-level information, the destination information, or the like), which is received through the user input reception unit 310, and the for-use-in-target-SOC value-prediction information, which is received through the for-use-in-target-SOC value-prediction information reception unit 320.

For example, the target SOC prediction module 352 may be configured to predict an SOC value necessary to perform the after-blow at the destination (the for-after-blow-performing SOC value) and an SOC value necessary for motor driving during traveling to the destination (the for-motor-driving SOC value).

Accordingly, the target SOC prediction module 352 may be configured to predict the target SOC value based on the for-after-blow-performing SOC value and the for-motor-driving SOC value.

Moreover, the target SOC prediction module 352 may re-predict the target SOC value for an update, whenever the setting information (for example, the after-blow strength-level information, the destination information, or the like), which is received through the user input reception unit 310, and the for-use-in-target-SOC value-prediction information, which is received through the for-use-in-target-SOC value-prediction information reception unit 320, are changed, or at predetermined time intervals.

The target SOC prediction module 352 may provide the predicted target SOC value to the charging-oriented traveling determination module 353.

The charging-oriented traveling determination module 353 may compare the target SOC value provided from the target SOC prediction module 352 and the current SOC value and may be configured to determine whether or not the charging-oriented traveling is enabled.

For example, when the current SOC value falls short of the target SOC value, the charging-oriented traveling determination module 353 may be configured to determine that the charging-oriented traveling is enabled and may output a charging-oriented traveling-enabling signal to the charging-oriented traveling enabling module 354. When the current SOC value reaches or exceeds the target SOC value, the charging-oriented traveling determination module 353 may be configured to determine that the charging-oriented traveling does not need to be enabled and may output a charging-oriented traveling-disabling signal to the charging-oriented traveling enabling module 354.

When receiving the charging-oriented traveling-enabling signal from the charging-oriented traveling determination module 353, the charging-oriented traveling enabling module 354 may enable the charging-oriented traveling by controlling low-level electricity-powered components, such as the engine clutch (E/C) and the low-level control unit 400.

In the present manner, through the charging-oriented traveling, the battery may be charged, and thus electric power for performing the after-blow may be secured.

According to the exemplary embodiment of the present disclosure, the target SOC prediction module 352, the charging-oriented traveling determination module 353, and the charging-oriented traveling enabling module 354 may continuously operate until receiving a destination arrival signal from the after-blow performing determination module 355.

The after-blow performing determination module 355 may be configured to determine whether or not the vehicle arrives at the destination. When the vehicle arrives at the destination, the after-blow performing determination module 355 may output the destination arrival signal to the target SOC prediction module 352, the charging-oriented traveling determination module 353, and the charging-oriented traveling enabling module 354.

In a case where the vehicle does not arrive at the destination, the after-blow performing determination module 355 may not output the destination arrival signal or may output a destination non-arrival signal to the target SOC prediction module 352, the charging-oriented traveling determination module 353, and the charging-oriented traveling enabling module 354.

For example, when receiving destination arrival information (or the destination arrival signal) from a predetermined device (for example, a navigation device), the after-blow performing determination module 355 may be configured to determine that the vehicle arrives at the destination.

In the present manner, the after-blow performing determination module 355 operates according to whether or not the destination arrival information is received.

In a case where the vehicle arrives at the destination, the after-blow performing determination module 355 may be configured to determine whether or not a condition for performing after-blow is satisfied. When determining that the condition for performing after-blow is satisfied, the after-blow performing determination module 355 may output an after-blow performing signal to the after-blow performing module 356.

For example, the after-blow performing determination module 355 may output the after-blow performing signal to the after-blow performing module 356 in the case where the IG OFF state is attained, where humidity is 80% or higher than 80%, where the difference between inside air and outside air is 15° C. or higher than 15° C., where the air conditioner 500 operates for a 5 minutes or longer than 5 minutes during traveling, and where the current SOC value reaches or exceed the preset for-after-blow-performing SOC value.

When receiving the after-blow performing signal from the after-blow performing determination module 355, the after-blow performing module 356 may perform the after-blow function by operating the air conditioner 500.

According to the exemplary embodiment of the present disclosure, the after-blow performing module 356 may perform the after-blow function based on the setting information which is input by the user, information which is generated when predicting the target SOC value, and the like.

For example, the after-blow performing module 356 may perform the after-blow function based on the after-blow strength-level (or intensity-level) information (for example, the weak-wind level, the middle-wind level, the strong-wind level, or the automatically adjusted level) which is input by the user, and the after-blow duration time information.

For example, the after-blow performing module 356 may perform the after-blow function based on the after-blow strength-level (or intensity-level) information (for example, the weak-wind level, the middle-wind level, the strong-wind level, or the automatically adjusted level) which is input by the user, and after-blow performing time information, which is generated while predicting the for-after-blow-performing SOC value.

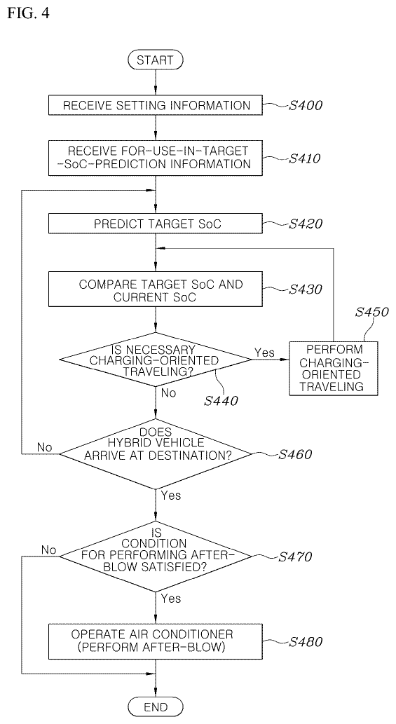

FIG. 4 is a flowchart which is referred to for description of operations by the system for performing an after-blow function according to the exemplary embodiment of the present disclosure.

Stepwise operations that are illustrated in FIG. 4 may be performed by the system 1 for performing an after-blow function which is described with reference to FIG. 1, FIG. 2, and FIG. 3.

A method of performing an after-blow function which is performed by the system 1 for performing an after-blow function will be described below with reference to FIG. 1, FIG. 2, FIG. 3, and FIG. 4, with a focus on the high-level control unit 300 (or the apparatus for performing an after-below function) that operates to perform the after-blow.

First, the high-level control unit 300 may receive the setting information which is input through the user input interface 100 (S400).

The setting information may include the after-blow strength-level (or intensity-level) information (for example, the weak-wind level, the middle-wind level, the strong-wind level, or the automatically adjusted level), the after-blow duration time information, the destination information and the like.

According to the exemplary embodiment of the present disclosure, the high-level control unit 300 may initially receive the setting information (the initial setting information) and then may receive new setting information (the change-resulting setting information) that results from the user changing the initial setting information).

Accordingly, the high-level control unit 300 may receive the information (the for-use-in-target-SOC value-prediction information) which is used in predicting the target SOC value, from the for-use-in-target-SoC-prediction information provision unit 200 (S410).

According to the exemplary embodiment of the present disclosure, the high-level control unit 300 may receive the initial (or pre-driving) for-use-in-target-SOC value-prediction information and then may continuously receive the for-use-in-target-SOC value-prediction information (the during-driving for-use-in-target-SOC value-prediction information) while the vehicle drives.

Subsequently, the high-level control unit 300 may be configured to predict the target SOC value based on the setting information and the for-use-in-target-SOC value-prediction information (S420).

In Step S420, the high-level control unit 300 may be configured to predict the SOC value necessary to perform the after-blow at the destination (the for-after-blow-performing SOC value) and the SOC value necessary for motor driving during traveling to the destination (the for-motor-driving SOC value).

The high-level control unit 300 may be configured to predict the target SOC value based on the for-after-blow-performing SOC value and the for-motor-driving SOC value. For example, the high-level control unit 300 may be configured to predict the target SOC value by adding up the for-after-blow-performing SOC value and the for-motor-driving SOC value.

In Step S420, the high-level control unit 300 may be configured to predict the for-after-blow-performing SOC value by considering the after-blow duration time information which is included in the setting information.

Furthermore, the high-level control unit 300 may be configured to predict the after-blow performing time and then may be configured to predict the for-after-blow-performing SOC value by considering the predicted after-blow performing time.

According to the exemplary embodiment of the present disclosure, when receiving the change-resulting setting information or the during-driving for-use-in-target-SOC value-prediction information, for updates, the high-level control unit 300 may re-predict the for-after-blow-performing SOC value, the for-motor-driving SOC value, and the target SOC value by considering the received information.

Subsequently, the high-level control unit 300 may compare the target SOC value and the current SOC value (S430) and may be configured to determine whether or not the charging-oriented traveling is necessary (S440).

In Step S440, when the current SOC value falls short of the target SOC value, the high-level control unit 300 may be configured to determine that the charging-oriented traveling is necessary. Furthermore, when the current SOC value reaches or exceeds the target SOC value, the high-level control unit 300 may be configured to determine that the charging-oriented travel is not necessary.

In Step S440, when determining that the charging-oriented traveling is necessary (YES in S440), the high-level control unit 300 may enable the charging-oriented traveling for charging the battery (S450).

The high-level control unit 300 may reperform Step S430 after enabling the charging-oriented traveling and may repeatedly perform Steps S430 and S450 until the target SOC value is attained.

In Step S440, when determining that the charging-oriented traveling is not necessary (NO in S440), the high-level control unit 300 may be configured to determine whether or not the vehicle arrives at the destination (S460).

In Step S460, when determining that the vehicle does not arrive at the destination (NO in S460), the high-level control unit 300 may perform Step S420.

In Step S460, when determining that the vehicle arrives at the destination (YES in S460), the high-level control unit 300 may be configured to determine whether or not the condition for performing after-blow is satisfied (S470).

For example, the high-level control unit 300 may be configured to determine that the condition for performing after-blow is satisfied, in the case where the IG OFF state is attained, where humidity is 80% or higher than 80%, where the difference between inside air and outside air is 15° C. or higher than 15° C., where the air conditioner 500 operates for a 5 minutes or longer than 5 minutes during traveling, and where the current SOC value reaches or exceed the preset for-after-blow-performing SOC value.

In Step S470, in a case where the condition for performing after-blow is not satisfied (NO in S470), the high-level control unit 300 may not perform an operation of performing the after-blow so that the after-blow is not performed.

In Step S470, in a case where the condition for performing after-blow is satisfied (YES in S470), the high-level control unit 300 may perform the after-blow function by operating the air conditioner 500 (S480).

In Step S480, the high-level control unit 300 may perform the after-blow function based on the setting information which is input by the user, the information which is generated when predicting the target SOC value, and the like.

For example, the after-blow performing module 356 may perform the after-blow function based on the after-blow strength-level (or intensity-level) information (for example, the weak-wind level, the middle-wind level, the strong-wind level, or the automatically adjusted level) which is input by the user and the after-blow duration time information.

For example, the after-blow performing module 356 may perform the after-blow function based on the after-blow strength-level (or intensity-level) information (for example, the weak-wind level, the middle-wind level, the strong-wind level, or the automatically adjusted level) which is input by the user, and the after-blow performing time information, which is generated while predicting the for-after-blow-performing SOC value.

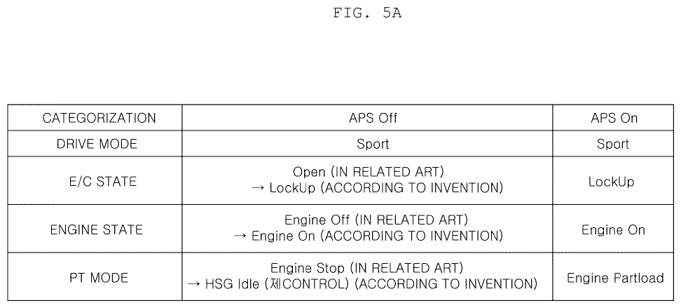

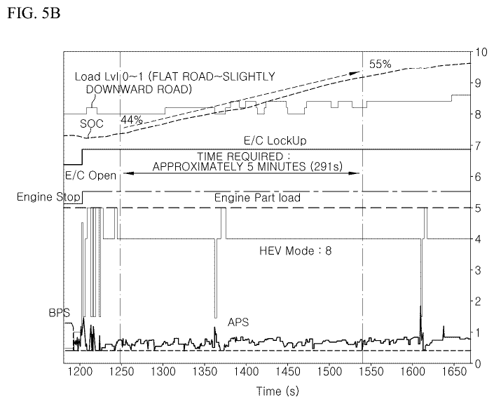

FIG. 5A is a table showing an example of a control state where the charging-oriented control according to the exemplary embodiment of the present disclosure is performed. FIG. 5B is a graph showing a result of conducting an experiment based on the control state in FIG. 5A.

The experiment based on the control state in FIG. 5A was conducted on a vehicle that performed the charging-oriented control in a state where an APS OFF state was attained while driving in a sports mode.

Usually, in a case where a hybrid vehicle drives in the sports mode as a drive mode, the engine clutch (E/C) is kept locked up while an APS ON state is maintained, and an engine is controlled in a mode (for example, in a part load mode) in which a predetermined air-fuel ratio is satisfied. In contrast, in a case where the APS OFF state is attained, although the hybrid vehicle drives in the sports mode, usually, the engine clutch (E/C) is disengaged, and the engine is turned off. However, to realize the charging-oriented control according to the exemplary embodiment of the present disclosure, the engine may operate even in the APS OFF state, and thus battery charging may be enabled in a more actively manner. This control type is shown in FIG. 5A.

From FIG. 5B, it may be seen that the BPS continuously indicated a value of almost 0 while the vehicle traveled on a flat road or a slightly downward road for five minutes and that in the instant state, the APS was repeatedly turned on or off. Usually, when the APS is turned off, the engine clutch (E/C) is disengaged. However, according to the exemplary embodiment of the present disclosure, although the APS is turned off, the charging-oriented control is performed so that the engine clutch (E/C) is kept locked up and that the engine also operates. Therefore, it may be seen that during a corresponding section, the engine operated at part load and that the engine clutch (E/C) was kept locked upwards.

It may be seen that, through the present control, an SOC value could increase by approximately 11% for five minutes under an experimental environment. That is, it may be seen that, when the APS was turned off in the vehicle that drove in the sports mode, an additional SOC value could be secured when the charging-oriented control was performed rather than common control (E/C Open, Engine Off, or Engine Stop in a PT mode) was performed.

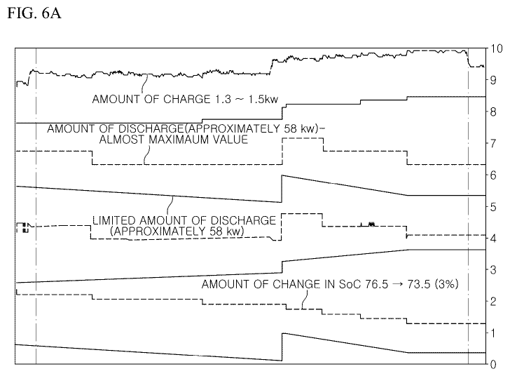

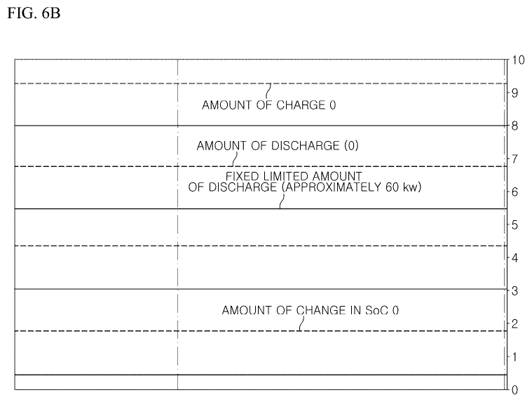

FIG. 6A and FIG. 6B are graphs each showing an experimental example which may be referred when realizing the algorithm for predicting the for-after-blow-performing SOC value.

The apparatus for performing an after-flow function according to the exemplary embodiment of the present disclosure may be configured to predict the SOC value using the algorithm for predicting an SOC value which is optimized through numerous experiments. The results of these experiments were obtained as shown on the graphs in FIG. 6A and FIG. 6B.

FIG. 6A is a graph showing the measured amount of a change in the SOC value what results when the engine operates for 15 minutes in a state where, while the engine is idle, the battery is charged with 1300 to 1500 W and an amount of discharge for operating the air conditioner is maximized. from FIG. 6A, it may be seen that the SOC value changed by 3% in a corresponding condition.

FIG. 6B is a graph showing the measured amount of a change in the SOC value that results when the air condition operates to blow air for five minutes while the engine is turned off. From FIG. 6B, it may be seen that the SOC value does not change in a corresponding condition.

When the air conditioner is operated at appropriate load for 30 minutes in a state where the engine is turned off, it may be predicted, based on the experimental results shown on the graphs in FIG. 6A and FIG. 6B, that the SOC value decreases by approximately 5 to 10%.

However, amounts of discharge and the like that are shown in FIG. 6A and FIG. 6B are exemplary. It would be apparent to a person of ordinary skill in the art that the SOC value is variously reduced according to configurations of the battery and the electricity-powered components.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for performing an after-blow function in a hybrid vehicle, the apparatus comprising:
an air conditioner; and
a controller configured to predict a target state-of-charge (SOC) value based on setting information for the after-flow function which is performed using the air conditioner, and for-use-in-target-SOC value-prediction information which is used in predicting the target SOC value for securing an SOC value necessary to perform the after-flow function, and to control the hybrid vehicle's traveling to a destination so that an SOC value at the destination at which the after-blow function is performed becomes the target SOC value.

2. The apparatus of claim 1, wherein the setting information includes after-blow performing-non-performing information, after-blow strength-level information, after-blow duration time information, and destination information.

3. The apparatus of claim 1, wherein the target SOC value includes a for-after-blow-performing SOC value necessary to perform the after-blow function and a for-motor-driving SOC value necessary for motor driving while the hybrid vehicle drives to the destination.

4. The apparatus of claim 1, wherein the controller is configured to predict an initial target SOC value based on initial setting information and initial for-use-in-target-SOC value-prediction information and to update the initial target SOC value in response that at least one of the setting information and the for-use-in-target-SOC value-prediction information is changed while the hybrid vehicle drives.

5. The apparatus of claim 1, wherein the controller is configured to continuously obtain a current SOC value while the hybrid vehicle travels, and in response that the current SOC value falls short of the target SOC value, to enable charging-oriented traveling so that the current SOC value becomes the target SOC value.

6. The apparatus of claim 1, wherein the controller is configured to perform the after-blow function in response that the hybrid vehicle arrives at the destination and an ignition (IG) OFF state is attained and where a predetermined condition is satisfied.

7. The apparatus of claim 6, wherein the controller is configured to perform the after-blow function in response that humidity at the destination, a difference between inside air and outside air, and time during which the air conditioner operates while the hybrid vehicle travels satisfy the predetermined condition.

8. The apparatus of claim 6, wherein the controller is configured to perform the after-blow function based on after-blow strength-level information and after-blow duration time information that are included in the setting information.

9. The apparatus of claim 6, wherein the controller is configured to perform the after-blow function based on after-blow strength-level information, which is included in the setting information, and after-blow performing time information, which is generated while the target SOC value is determined.

10. A system for performing an after-blow function, the system comprising:
a user input interface configured to receive setting information input from a user;
a for-use-in-target-SoC-prediction information provision unit configured to provide for-use-in target state-of-state (SOC) value prediction information which is used in predicting a target SOC value for securing an SOC value necessary to perform after-blow; and
an apparatus for performing the after-blow function in a hybrid vehicle, the apparatus including:
an air conditioner; and
a controller configured to predict a target state-of-charge (SOC) value based on setting information for the after-flow function which is performed using the air conditioner, and for-use-in-target-SOC value-prediction information which is used in predicting the target SOC value for securing an SOC value necessary to perform the after-flow function, and to control the hybrid vehicle's traveling to a destination so that an SOC value at the destination at which the after-blow function is performed becomes the target SOC value.

11. The system of claim 10, wherein the apparatus is configured to enable the SOC value at the destination to become the target SOC value by controlling an engine control unit, a motor control unit, a transmission control unit, a battery management system, and an engine clutch.

12. The system of claim 10, wherein the user input interface is a user setting menu (USM), and the apparatus is a hybrid control unit (HCU).

13. A method of operating an apparatus for performing an after-blow function, the apparatus being mounted in a hybrid vehicle, the method comprising:
predicting, by a controller, a target state-of-charge (SOC) value for securing an SOC value necessary to perform after-blow based on setting information and for-use-in-target-SOC value-prediction information;
comparing, by the controller, a current SOC value which is obtained while the hybrid vehicle travels and the target SOC value;
performing, by the controller, control so that charging-oriented traveling is enabled, in response that the current SOC value falls short of the target SOC value; and
performing, by the controller, the after-blow function in response that the hybrid vehicle arrives at a destination.

14. The method of claim 13, wherein in the predicting of the target SOC value, a for-after-blow-performing SOC value necessary to perform the after-blow function is predicted, a for-motor-driving SOC value necessary for motor driving while the hybrid vehicle drives to the destination is predicted, and the target SOC value is predicted based on the for-after-blow-performing SOC value and the for-motor-driving SOC value.

15. The method of claim 13, wherein in the predicting of the target SOC value, an initial target SOC value is predicted based on initial setting information and initial for-use-in-target-SOC value-prediction information, and the initial target SOC value is updated in response that at least one of the setting information and the for-use-in-target-SOC value-prediction information is changed while the hybrid vehicle drives.

16. The method of claim 13, wherein the comparing of the current SOC value which is obtained while the hybrid vehicle travels and the target SOC value is performed after the charging-oriented traveling is enabled.

17. The method of claim 13, wherein in the performing of the after-blow function, in response that the hybrid vehicle arrives at the destination and a preset condition is satisfied, the after-blow function is performed.

18. The method of claim 17, wherein in the performing of the after-blow function, in response that the hybrid vehicle is in an ignition (IG) OFF state and humidity at the destination, a difference between inside air and outside air, and time during which an air conditioner operates while the hybrid vehicle travels satisfy a preset condition, the after-blow function is performed.

19. The method of claim 17, wherein in the performing of the after-blow function, the after-blow function is performed based on after-blow strength-level information and after-blow duration time information that are included in the setting information.

20. The method of claim 17, wherein in the performing of the after-blow function, the after-blow function is performed based on after-blow strength-level information, which is included in the setting information, and after-blow performing time information, which is generated while the target SOC value is determined.
